(19) United States
(12) Patent Application Publication
(10) Pub. No.: US 2026/0010124 A1
(43) Pub. Date: Jan. 8, 2026

(54) WEARABLE ELECTRONIC DEVICE AND ASSOCIATED USER INTERFACE

(71) Applicant: COMPANION AUGMENT SOLUTION AB, Stockholm (SE)

(72) Inventor: Björn Thomas Eriksson, Tynningö (SE)

(73) Assignee: COMPANION AUGMENT SOLUTION AB, Stockholm (SE)

(21) Appl. No.: 18/993,856

(22) PCT Filed: May 20, 2024
(86) PCT No.: PCT/SE2024/050489

§ 371 Date: Jan. 13, 2025

Related U.S. Application Data
(60) Provisional application No. 63/467,981, filed on May 21, 2023.

(51) Int. Cl. G04G 21/02; G04G 9/04; G04G 17/04; G06F 3/01

(52) U.S. Cl. CPC G04G 21/02; G04G 9/04; G04G 17/04; G06F 3/017

(57) ABSTRACT

An electronic watch, including a display featuring pixels, and a printed circuit board (PCB) surrounding the pixels, a first group of light detectors on the PCB on the right circumference of the pixels, that, when activated, output values of ambient light received by the detectors in that group, a second group of light detectors on the PCB on the left circumference of the pixels, that, when activated, output values of ambient light received by the detectors in that group, a processor connected to the first and second groups, that activates each group and stores the group output values, a computer-readable medium storing code which causes the processor to identify an in-air wave gesture by an object that traverses the airspace above the display, and a direction of the gesture, wherein the direction is left to right or right to left, based on outputs of the first and second groups.

### FIELD OF THE INVENTION

The present invention relates to wearable electronic devices, and in particular, electronic watches and smartwatches.

### BACKGROUND OF THE INVENTION

Wearable devices, such as smartwatches, are becoming ubiquitous. Such devices may connect via proximity-based network connections to other devices, for example connecting a smartwatch to a mobile phone via a Bluetooth connection. Wearable devices, and particularly smartwatches and electronic watches, feature displays that are much smaller than mobile phone displays, making user interfaces for mobile phones awkward for use in a smartwatch or similar wearable device. The smaller display on an electronic watch presents additional challenges to device designers and manufacturers, as every display includes a non-active peripheral portion of the display. On these smaller displays, the percentage of screen area lost to the non-active peripheral portion is significant compared to mobile phone and tablet displays. The present invention addresses these and other shortcomings in the prior art.

### SUMMARY

Embodiments of the present invention provide an electronic watch, including a housing, a display mounted in the housing, including a plurality of display pixels, and a printed circuit board (PCB) surrounding the plurality of display pixels, a first group of light detectors mounted on the PCB, including a plurality of light detectors on the right circumference of the display pixels, that, when activated, output values representing amounts of ambient light received by the light detectors in that group, a second group of light detectors mounted on the PCB, including a plurality of light detectors on the left circumference of the display pixels, that, when activated, output values representing amounts of ambient light received by the light detectors in that group, a processor mounted in the housing, connected to the first and second groups of light detectors, that activates each group and stores the group output values, a non-transitory computer-readable medium connected to the processor and storing a computer program with computer program code which, when read by the processor, causes the processor to identify (i) an in-air wave gesture by a light obstructive object that traverses the airspace above the display, and (ii) a direction of the gesture, wherein the direction is left to right or right to left, based on outputs of the first and second groups of light detectors.

According to further features in embodiments of the invention, for each group of light detectors, outputs from all light detectors in the group are connected to a single input pin on the processor.

According to further features in embodiments of the invention, the computer program code, when read by the processor, further causes the processor to identify, for each of the groups of light detectors, whether the light obstructive object is positioned above that group based on outputs from that group.

According to further features in embodiments of the invention, the computer program code, when read by the processor, further causes the processor to cease activating the display pixels when the processor identifies that the light obstructive object is positioned above both groups of light detectors.

According to further features in embodiments of the invention, the computer program code, when read by the processor, further causes the processor to reactivate the display pixels after the cease activating, in response to the processor identifying that the light obstructive object is no longer positioned above at least one of the groups of light detectors.

According to further features in embodiments of the invention, the computer program code, when read by the processor, further causes the processor to identify an in-air approach gesture by a light obstructive object that approaches the display in the airspace above the display based on outputs of the first and second groups of light detectors.

According to further features in embodiments of the invention, the left group includes an upper left group and a lower left group, and the right group includes an upper right group and a lower right group, and the computer program code, when read by the processor, further causes the processor to identify (i) an in-air wave gesture by a light obstructive object that traverses the airspace above the display in a diagonal direction, and (ii) the diagonal direction, wherein the diagonal directions are between upper left of the display and lower right of the display, and between lower left of the display and upper right of the display, based on outputs of the groups of light detectors.

Embodiments of the present invention further provide an electronic watch, including a housing, a display mounted in the housing, the display including a substrate having an active area and an inactive area, a plurality of display pixels in the active area of the substrate, and peripheral circuitry in the inactive area of the substrate, configured to drive the display pixels, a PCB mounted above the inactive area of the substrate, a plurality of light detectors mounted on the PCB, that, when activated, receive ambient light and output values representing the amounts of light received, a fiber optic faceplate mounted in the housing above the display, acting as a zero-depth window for the display pixels in the active area of the substrate, wherein a distance between a bottom surface of the faceplate and the light detectors is sufficiently small to limit the optical fibers through which light rays can pass to each of the detectors, and a processor mounted in the housing, connected to the detectors, activating each of the detectors and storing detector output values, a non-transitory computer-readable medium connected to the processor and storing a computer program with computer program code which, when read by the processor, causes the processor to identify, for each of the detectors, whether a light obstructive object is positioned above that detector blocking ambient light from arriving at that detector, based on outputs from that detector.

According to further features in embodiments of the invention, the computer program code, when read by the processor, further causes the processor to calculate a position of a light obstructive object above the fiber optic faceplate by interpolating outputs from a plurality of the detectors.

According to further features in embodiments of the invention, the computer program code, when read by the processor, further causes the processor to determine whether the fiber optic faceplate is exposed or covered, based on the identify, and in response to determining that the fiber optic faceplate is covered, cease activating the display pixels in order to minimize electronic watch power consumption.

According to further features in embodiments of the invention, the computer program code, when read by the processor, further causes the processor to determine when the fiber optic faceplate is transitioning from being covered to being exposed, based on increased outputs from a plurality of the detectors, wherein the number of detectors whose outputs increase, grows over time, and in response to the determined transitioning, reactivate the display pixels.

According to further features in embodiments of the invention, the computer program code, when read by the processor, further causes the processor to: recognize in-air wave gestures performed above the fiber optic faceplate, based on ambient light being blocked from different ones of the detectors by an object performing the in-air wave gesture.

According to further features in embodiments of the invention, the computer program code, when read by the processor, further causes the processor to: recognize in-air approach gestures performed above the fiber optic faceplate, based on reduced detector output values as an object approaches the fiber optic faceplate.

According to further features in embodiments of the invention, the computer program code, when read by the processor, further causes the processor to: identify finger-glide gestures performed along the fiber optic faceplate above the inactive area of the substrate, based on changes in amounts of ambient light being detected by each of the detectors along the path of the gesture.

According to further features in embodiments of the invention, the electronic watch further includes a plurality of light emitters mounted on the PCB, that, when activated by the processor, emit light through the fiber optic faceplate, whereby the fiber optic faceplate acts as a zero-depth window for the light emitters.

According to further features in embodiments of the invention, the computer program code further causes the processor to activate the emitters in an activation pattern or animation indicating a current time of day.

According to further features in embodiments of the invention, the light emitters surround the active area and are mapped to a clock face dial indicating the hours in a 12-hour cycle, wherein the activation pattern includes activating a series of the emitters, the series beginning at that location mapped to the twelve o'clock position and terminating at that location mapped to the position of the current time of day within the 12-hour cycle.

According to further features in embodiments of the invention, the light emitters surround the active area and are mapped to a clock face dial indicating the hours in a 12-hour cycle and the minutes in a 60-minute hour, wherein the activation pattern includes initially activating a first one or more of the emitters at that location mapped to the position within the 12-hour cycle of the current hour of day, followed by further activating a series of the emitters beginning at that location mapped to the twelve o'clock position and terminating at that location mapped to the position within the 60-minute hour of the number of minutes past the current hour.

According to further features in embodiments of the invention, the computer program code further causes the processor to: determine when the fiber optic faceplate is transitioning from being covered to being exposed, based on a series of neighboring ones of the detectors outputting increased values during a time interval, and in response to the determined transitioning, activate the emitters in the activation pattern indicating the current time of day.

Embodiments of the present invention provide an electronic watch, including a watch housing, a PCB mounted in the housing, a processor mounted on the PCB, a display mounted in the housing above the PCB, a cylindrical, battery housing configured to be fastened in the watch housing, beneath the PCB, by a bayonet mount fastening mechanism, the bayonet mount fastening mechanism including one or more radial spring-loaded pins extending from the battery housing and corresponding concave targets in the watch housing, a rechargeable battery mounted in the cylindrical battery housing, a plurality of spring-loaded connector pins extending from the PCB, mated to a corresponding plurality of convex mating receptacles in the battery housing, for connecting the battery to the PCB.

According to further features in embodiments of the invention, one of the convex mating receptacles is located at the center of the flat surface of the battery housing opposite the PCB and connects the battery to ground.

According to further features in embodiments of the invention, the battery housing further includes a toric joint surrounding the plurality of convex mating receptacles, to form a seal at an interface between the battery housing and the watch housing.

According to further features in embodiments of the invention, the electronic watch includes a charging coil mounted in the battery housing underneath the battery for charging the battery, and a convex glass cover underneath the charging coil.

According to further features in embodiments of the invention, the electronic watch includes a light emitter mounted in the battery housing, configured to illuminate the convex glass cover.

According to further features in embodiments of the invention, the light emitter is a multicolor LED configured to be illuminated to indicate a status of the battery being charged via the charging coil.

According to further features in embodiments of the invention, the electronic watch includes a pulse meter light detector mounted in the battery housing, detecting light from the light emitter reflected by the electronic watch wearer's wrist.

According to further features in embodiments of the invention, the electronic watch includes an additional battery housing to replace the battery housing, wherein the additional battery housing is taller than the battery housing in order to accommodate a rechargeable battery that is larger than the rechargeable battery.

According to further features in embodiments of the invention, the electronic watch includes a crown, mounted in a socket in the exterior of the watch housing wherein the socket is hermetically separated from the interior of the watch housing, a short-range wireless technology integrated circuit (IC) mounted on the PCB, and an ultra-wideband (UWB) antenna mounted in the crown, wherein the processor communicates with a mobile phone or remote computer via the antenna and the IC.

According to further features in embodiments of the invention, the crown with the ultra-wideband (UWB) antenna is made of glass or acrylic.

According to further features in embodiments of the invention, the watch housing is made of metal and acts as a ground plane for the antenna.

According to further features in embodiments of the invention, the electronic watch includes a crown, mounted in a socket in the exterior of the watch housing in a manner enabling rotation and translation of the crown, wherein the socket is hermetically separated from the interior of the watch housing, a plurality of magnets attached to that portion of the crown in the socket, and a magnetic sensor mounted on the PCB, configured to measure three magnetic flux components (BX, BY and BZ) of the magnets rotated and translated by the crown, wherein the magnetic sensor sends rotation and translation data to a processor mounted on the PCB for controlling functions of the electronic watch.

### BRIEF DESCRIPTION OF THE DRAWINGS

The present invention will be more fully understood and appreciated from the following detailed description, taken in conjunction with the drawings in which:

FIG. 1 is a top view of an electronic watch, in accordance with an embodiment of the present invention;

FIG. 2 is a bottom view of an electronic watch, in accordance with embodiment of the present invention;

FIG. 3 is a perspective view of an electronic watch, with the crown covers removed, in accordance with an embodiment of the present invention;

FIG. 4 is illustrates how a crown is mounted in an electronic watch, in accordance with an embodiment of the present invention;

FIG. 5 is a perspective view of an electronic watch with its outer casing removed, in accordance with an embodiment of the present invention;

FIG. 6 is a perspective view of the upper interior elements in an electronic watch, in accordance with an embodiment of the present invention;

FIG. 7 is a side view of the upper interior elements in an electronic watch, in accordance with an embodiment of the present invention;

FIG. 8 is enlarged view of a portion of FIG. 6, in accordance with an embodiment of the present invention;

FIG. 9 is perspective view from the bottom, of the upper interior elements in an electronic watch, in accordance with an embodiment of the present invention;

FIG. 10 is a side view of interior elements in an electronic watch, in accordance with an embodiment of the present invention;

FIG. 11 is an exploded top perspective view of an electronic watch, in accordance with an embodiment of the present invention;

FIG. 12 is an exploded side view of an electronic watch, in accordance with an embodiment of the present invention;

FIG. 13 is an exploded view of the bottom portion of an electronic watch, in accordance with an embodiment of the present invention;

FIG. 14 is an exploded bottom perspective view of an electronic watch, in accordance with an embodiment of the present invention;

FIG. 15 is an exploded view of a battery pack for an electronic watch, in accordance with an embodiment of the present invention;

FIG. 16 is a simplified illustration of an electronic watch worn by a user, in accordance with an embodiment of the present invention;

FIG. 17 is simplified illustration a user interface hand wave gesture for an electronic watch, in accordance with an embodiment of the present invention; and

FIGS. 18-20 are simplified illustrations a user interface finger-spread gesture for an electronic watch, in accordance with an embodiment of the present invention.

In the disclosure and figures, the following numbering scheme is used. Like numbered elements are similar but not necessarily identical.

TABLE I
Elements of Figures

| Type of element | Numbering range | FIGS. |
|---|---|---|
| Electronic watch | 505 | 1, 3, 11, 12, 14, 16, |
| | | 19, 20 |
| Watch strap | 506 | 16, 17 |
| Faceplate | 507-510 | 1, 3, 5-12, 14 |
| Watch dial | 515 | 1 |
| Watch casing | 516 | 1-4, 11, 12, 14 |
| Watch casing partition | 517 | 14 |
| Crown | 520, 530, 540 | 1, 2, 4 |
| Crown base | 521, 524, 531, 532, | 3 |
| | 541, 542 | |
| Crown ball bearings | 522, 525, 533, 534, | 3 |
| | 543, 544 | |
| Ultra-wideband | 535 | 3, 11 |
| (UWB) antenna | | |
| Magnet | 545, 546 | 4 |
| Main PCB | 600 | 4-10 |
| Flex PCB | 601 | 5-8, 10, 11 |
| Flex PCB connector | 602 | 6, 7, 9 |
| OLED display | 605 | 5-11 |
| Vibrator | 610 | 7, 9 |
| Spring-loaded pin connector | 611-615 | 7, 9, 10, 14 |
| Connector mating receptacle | 621-625 | 10, 11, 13 |
| Tri-axis magnetic sensor IC | 616 | 4 |
| Processor | 617 | 4, 9 |
| Toric joint or O-ring gasket | 626 | 13, 15 |
| Side spring-loaded pins | 632, 633 | 11, 13, 14 |
| Battery pack | 640 | 2, 3, 13, 15 |
| Battery pack housing | 641 | 11-15 |
| Battery cell | 642 | 5, 10, 11, 13-15 |
| Battery pack cover glass | 643 | 2, 11-15 |
| Wireless charging coil | 644 | 15 |
| Bezel | 645 | 13 |
| Charge indicator LED | 646 | 15 |
| Light emitting diode (LED) | 701, 702 | 6, 8 |
| Photodiode (PD) | 761 | 6, 8 |
| Wrist | 800 | 16-20 |
| Hand | 801 | 17 |
| Finger | 802, 803 | 18-20 |
| Directional arrow | 810-819 | 17 |

### DETAILED DESCRIPTION

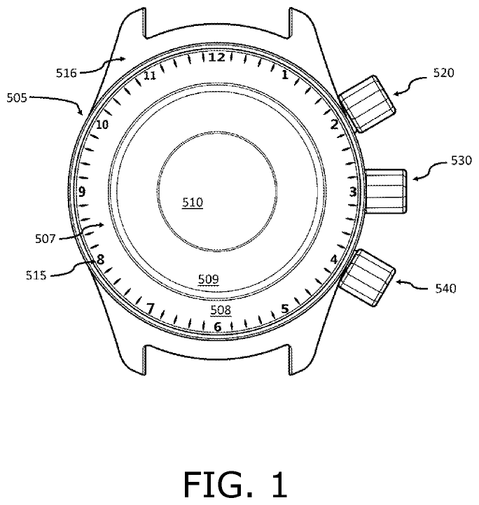

Reference is made to FIG. 1, which is a simplified illustration of a top view of electronic watch 505, in accordance with an embodiment of the present invention. FIG. 1 shows watch casing 516 and fiber optic faceplate 507. Mixed Arabic/stick markings etched into fiber optic faceplate 507 form watch dial 515. Watch hands (not shown) are rendered on a display, mounted inside casing 516, viewed through fiber optic faceplate 507. Faceplate 507 features multiple, cut and polished, exposed upper surfaces 508-510. Outer surface 508 featuring etched watch dial 515 along its outer edge is the highest of the exposed, upper surfaces. Surface 508 slopes downward as it extends outward. Inner surface 509 is sunk from outer surface 508. Inner surface 509 is sloped in the opposite direction of outer surface 508, sloping downward and inward, towards flat, circular, polished surface 510 at the center of faceplate 507. Flat, polished surface 510 is the lowest exposed upper surface of faceplate 507. As faceplate 507 transfers the image from an underlying display to the upper surface of faceplate 507, surfaces 508-510 provide the wearer of watch 505 with a rich, 3D visual presentation of the underlying watch display.

Electronic watch 505 includes three crowns 520, 530 and 540. Each crown can be rotated around its axis and translated along its axis into casing 516. In embodiments of the invention, the crowns are transparent or translucent, and are made of acrylic or glass.

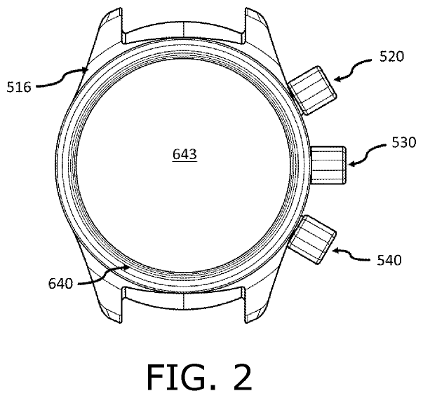

Reference is made to FIG. 2, which is a simplified rear view illustration of electronic watch 505, in accordance with an embodiment of the present invention. Removable, rechargeable battery pack 640 is stored in the bottom portion of watch casing 516. The front of battery pack 640 forms the rear surface of electronic watch 505 when battery pack 640 is inserted into watch casing 516. The front of battery pack 640 is mostly covered with cover glass 643.

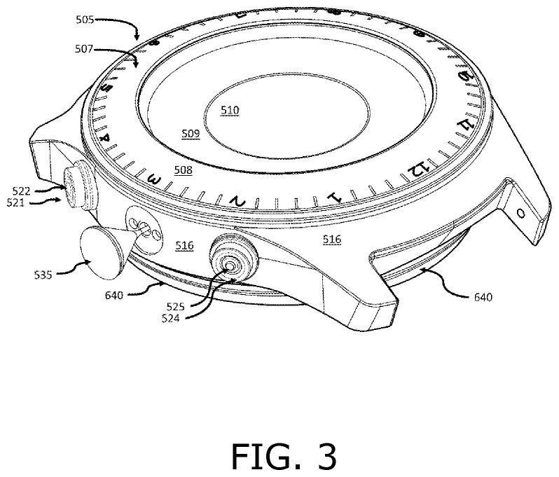

Reference is made to FIG. 3, which is a perspective view of electronic watch 505 showing faceplate 507, housing 516 and battery pack 640. Three exposed upper surfaces of faceplate 507, specifically, surfaces 508-510 are indicated. The glass or acrylic covers of crowns 520, 530 and 540 have been removed in this figure. Inside crown 520 there is a crown base 521 and ball bearings 522. Similarly, inside crown 540 there is a crown base 524 and ball bearings 525. Inside crown 530 there is an ultra-wideband (UWB) antenna 535 via which an UWB integrated circuit mounted in electronic watch 505 communicates with a nearby mobile phone or remote computer. Antenna 535 is cone-shaped and can be seen through the glass or acrylic cover of crown 530. Housing 516 is made of metal and acts as a ground plane for UWB antenna 535.

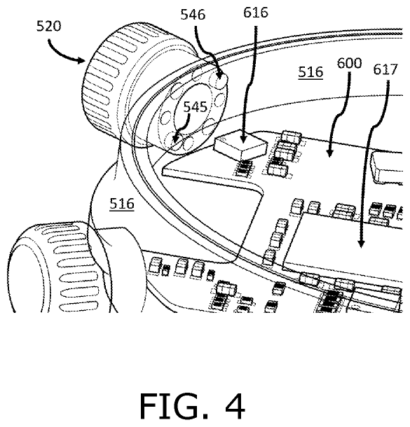

Reference is made to FIG. 4, illustrating how crowns 520 and 540 function. Each crown is attached to housing 516 from the outside in a manner enabling rotation and translation of the crown, while being separated from the housing 516 internal cavity by a solid wall. Because crowns 520 and 540 are physically separated from the housing 516 internal cavity, there is no risk of moisture entering watch 505 through the mountings of these crowns. Movements of the crown are detected by tri-axis magnetic sensor 616. A plurality of magnets 545, 546 is attached to the base of each crown. Magnets 545 and 546 are rotated and translated together with crown 520, and tri-axis magnetic sensor 616, mounted on PCB 600 is configured to measure three magnetic flux components (BX, BY and BZ) of magnets 545 and 546 rotated and translated by crown 520. Tri-axis magnetic sensor 616 sends rotation and translation data to processor 617 as input for configuring settings of watch 505.

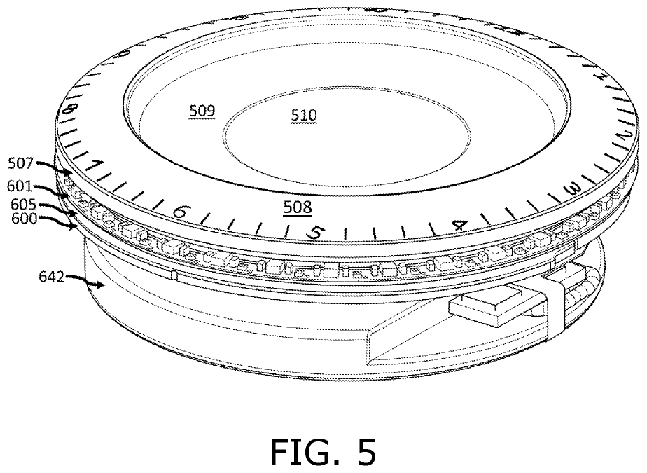

Reference is made to FIG. 5, which is a perspective view of electronic watch 505 without casing 516, showing five layers of components: battery cell 642 at the bottom; main PCB 600 above the battery; OLED display 605 above the main PCB; ring-shaped flex PCB 601 above the inactive perimeter of the OLED display, on which LEDs and light detectors (PDs) are mounted; and faceplate 507 covering the LEDs and PDs and the OLED display. Flex PCB 601 is connected to main PCB 600 via a flex-PCB connector that extends around OLED display 605. OLED display 605 includes an inner, active area that includes a plurality of display pixels, and an inactive area along the perimeter of OLED display 605 that does not include display pixels.

Embodiments of the invention operate as a smartwatch, running applications on the processor in the watch casing. Other embodiments of the invention operate as a dumb terminal, whereby applications for the watch-including timekeeping, are performed by a server computer that streams output images to the watch over wireless networks and/or 5G cellular networks. User input to the watch, such as gesture input detected by the PDs surrounding the display pixels and rotations of crowns 520, 530 and 540 are transmitted back to the server computer which generates new output for the watch in response thereto. The operation of the server and its communication over wireless networks and other features of this embodiment are discussed in PCT application no. PCT/SE2024/050467, filed on May 24, 2024, which is hereby incorporated herein in its entirety by reference.

Faceplate 507 is a fiber optic faceplate made up of glass fibers arranged parallel to one another and fused together in a coherent bundle to transfer an image from the plane under the faceplate to the plane above the faceplate. The bottom surface of faceplate 507 is split into two levels: a central bottom surface and an outer ledge. The central bottom surface is sufficiently close to the active, central portion of display 605 to transfer the image on the display to the upper surfaces 508-510 of the faceplate. The outer perimeter of the bottom surface of faceplate 507 is slightly higher than the bottom surface, so that it extends as an eave covering the LEDs and PDs mounted on flex PCB 601. This eave transfers the image on the illuminated LEDs to the upper surface of the faceplate. The eave along the perimeter of the bottom surface of faceplate 507 is sufficiently close to the PDs so as to limit the optical fibers through which light rays of ambient light can pass to each of the PDs.

The different surfaces 508-510 provide the wearer of watch 505 with a rich, visual presentation of the underlying watch display. In certain cases, the display presents a news crawl, such as a news ticker (sometimes called a crawler, crawl, slide, zipper, or ticker tape) in the form of scrolling text running along the outer edge of the circular display. This portion of display 605 is directly underneath surface 508 and is thus transferred to that portion of surface 508 that is interior to the etched dial 515, making this news ticker stand apart from the rest of the display shown on surfaces 509 and 510. One example of content for the news ticker is stock market data for stocks that the user has selected. In other cases, the image presented on display 605 is spread across surfaces 508-510. The etched dial on surface 508 is situated above the ring of LEDs and PDs mounted above the inactive portion of display 605 on ring-shaped PCB 605. Thus, no part of the image on display 605 is transferred to the outer portion of surface 508 on which the dial is etched. However, this outer portion of surface 508 is illuminated by the LEDs on ring-shaped PCB 605.

By limiting the optical fibers through which light rays of ambient light can pass to each of the PDs mounted on ring-shaped PCB 605, each PD is operative to detect when an object, such as a user's finger or a shirt sleeve is placed directly above that particular PD, as the object blocks ambient light from reaching the PD. Electronic watch 505 uses this feature to detect:
user gestures in the form of wave gestures above the watch;
user gestures in the form of finger glide gestures along watch dial 515;
multi-finger spread and pinch gestures on faceplate 507;
a degree of ambient light in the room; and.
when the watch is covered and uncovered, e.g., by the user's clothing.

In embodiments of the invention, the PDs mounted on ring-shaped PCB 605 are utilized in groups. Thus, for example, outputs from a first group of the PDs on the right circumference of the display pixels, and outputs from a second group of the PDs on the left circumference of the display pixels, enable processor 617 to identify an in-air wave gesture by a light obstructive object that traverses the airspace above the display, and a direction of the gesture, wherein the direction is left to right or right to left, based on outputs of the first and second groups of light detectors. In certain embodiments, outputs from all light detectors in the right group are connected to a first of two input pins on processor 617, and outputs from all light detectors in the left group are connected to a second of the two input pins on processor 617.

In certain embodiments of the invention, the left group of PDs includes an upper left group and a lower left group, and the right group of PDs includes an upper right group and a lower right group. Based on outputs from these four PD groups, processor 617 identifies diagonal directions of the in-air wave gesture, namely, diagonal directions between upper left and lower right of the display, and between lower left and upper right of the display, based on outputs of the four groups of PDs. In certain embodiments, outputs from all light detectors in each group (upper right, upper left, lower right and lower left) are connected to single input pin on processor 617 corresponding to that group.

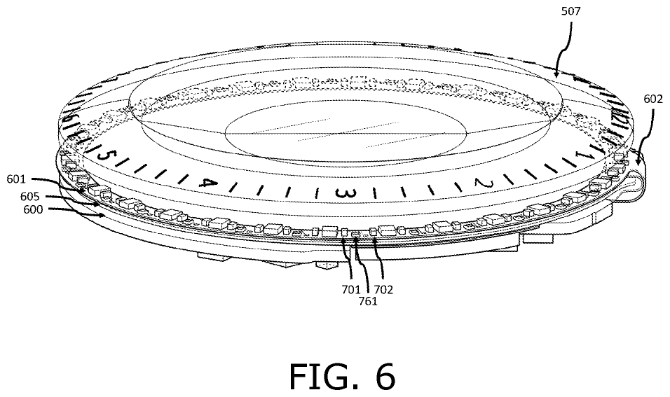

Reference is made to FIG. 6, showing a ring of 60 LEDs 701-760 and 30 PDs 761-790 directly above the peripheral, inactive portion of display 605, and directly underneath watch dial markings 515 etched into faceplate 507. In order to reduce clutter in FIG. 6, only LEDs 701, 702 and PD 761 are numbered. This ring of 60 LEDs enables selectively illuminating portions of watch dial 515 by selectively illuminating specific LEDs. Thus, electronic watch 505 provides the user with active feedback in that portion of an electronic watch display that is inactive in prior art electronic watches, specifically, the inactive display area. Specific user interfaces are discussed hereinbelow.

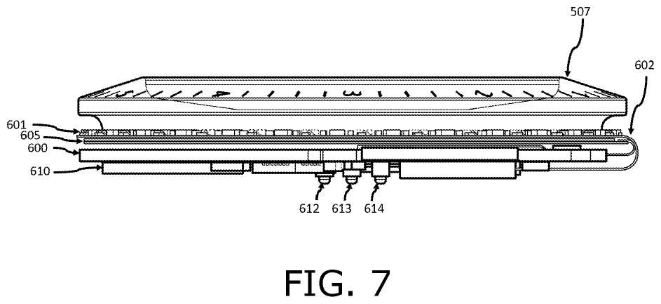

Reference is made to FIG. 7, showing main PCB 600, OLED display 605, ring-shaped flex PCB 601 and faceplate 507. FIG. 7 also shows flex connector 602 curved around display 605 to connect main PCB 600 and ring-shaped flex PCB 601. Vibrator 610 is shown mounted on the underside of main PCB 600. Spring-loaded connector pins 612, 613 and 614 are shown extending downward from main PCB 600, for connecting the main PCB to the battery (not shown).

A spring-loaded pin features three main parts: a plunger, a barrel, and a spring. When force is applied to the spring-loaded pin, the spring is compressed and the plunger moves inside the barrel. The shape of the barrel retains the plunger, stopping the spring from pushing it out when the pin is not locked in place. In embodiments of the invention, each spring-loaded connector pin includes an integrated helical spring in the pin that applies a constant normal force against the back of the mating receptacle or contact plate, counteracting any unwanted movement which might otherwise cause an intermittent connection.

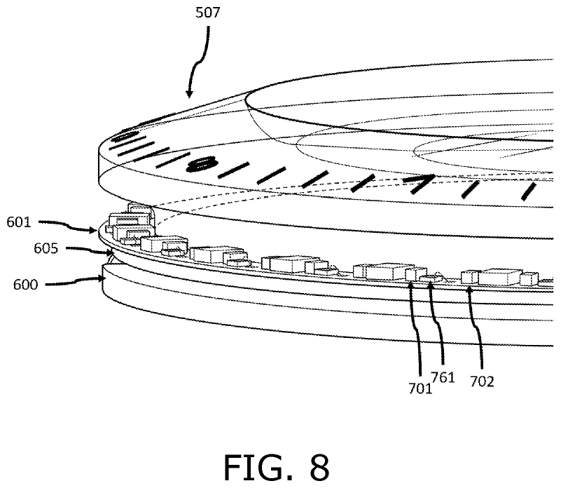

Reference is made to FIG. 8, showing a portion of ring-shaped flex PCB 601 and faceplate 507. FIG. 8 illustrates the different heights of the bottom surface of faceplate 507: the inner portion of faceplate 507 extends downward to meet the active inner portion of display 605, whereas the outer portion of faceplate 507 extends as an eave above the LEDs and PDs.

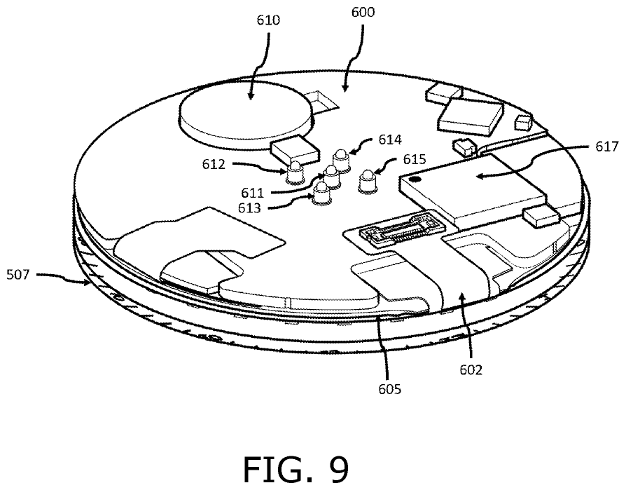

Reference is made to FIG. 9, illustrating the underside of main PCB 600. FIG. 9 shows processor 617 and vibrator 610 mounted on the underside of PCB 600, flex connector 602 curved around display 605 connecting main PCB 600 under the display with ring-shaped flex PCB 601 above the display. Non-volatile memory storing program code for processor 617 is mounted on the top side (not shown) of PCB 600. Five spring-loaded pins 611-615 are shown for connecting main PCB 600 to the removable battery pack (not shown). It will be explained hereinbelow that the removable battery pack is attached to housing 516 using a bayonet mount mechanism. Spring-loaded pin 611 is located opposite its corresponding concave metal mating receptacle at the center of the battery pack 640 bottom surface. Thus, when cylindrical battery pack 640 is inserted into watch housing 516 and rotated in place to engage the bayonet mount mechanism, spring-loaded pin 611 is the first pin to contact its mating receptacle, or land, when the battery pack is rotated into place. For the same reason, spring-loaded pin 611 is also the last pin to have contact with its mating receptacle, or land, in the battery pack when battery pack 640 is separated from housing 516 by a rotation in the opposite direction to disengage the bayonet mount mechanism. Therefore, spring-loaded pin 611 is designed to connect the battery to ground. Spring-loaded pins 612-615 are connected to the battery only after the battery has been rotated and secured in place by the bayonet mount mechanism, and these spring-loaded pins provide power and communication between the battery pack and main PCB 600.

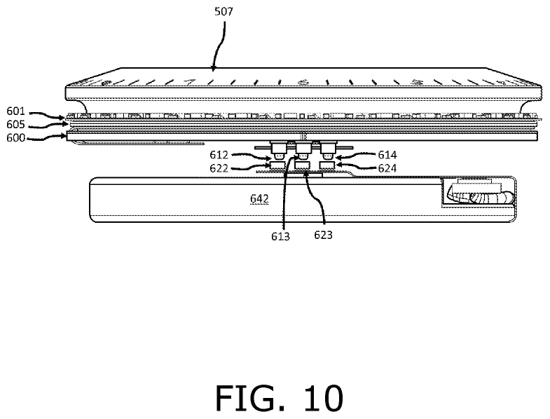

Reference is made to FIG. 10, which is a side view of stacked components in an electronic watch, showing spring-loaded pin connectors 612, 613 and 614 extending from the underside of main PCB 600 opposite their respective concave mating receptacles 622, 623 and 624, that connect these spring-loaded pin connectors to battery cell 642. The concave mating receptacles, or targets, unlike the pins, have no moving parts.

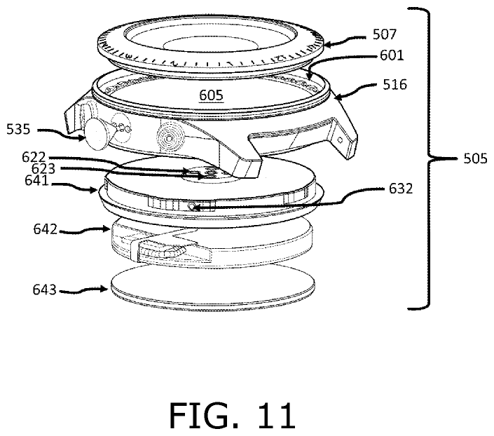

Reference is made to FIG. 11, which is an exploded, perspective view of stacked components in electronic watch 505. FIG. 11 shows faceplate 507 above watch housing 516. Both display 605 and ring-shaped PCB 601 on which LEDs and PDs are mounted above the inactive perimeter of display 605 are shown inside housing 516. FIG. 11 also shows the interior components of crowns 520 and 540 and antenna 535. A cover for crown 530 covering antenna 535 is not shown in FIG. 11.

FIG. 11 also shows exploded components of a battery pack: battery pack housing 641, battery cell 642, and battery pack cover glass 643. The battery pack is mechanically attached to watch housing 516 using a bayonet mount mechanism. A number of different battery packs are provided to enable the user to quickly and easily swap a watch battery whose charge has been depleted with a fully charged battery. Different battery packs contain battery cells having different capacities, whereby a battery pack containing a larger battery cell is thicker than a battery pack containing a smaller battery cell, but both packs are designed for insertion into the underside of watch housing 516, secured with a bayonet mount, and mated with spring-loaded pins 611-615. The thick battery pack containing the larger battery cell extends further from the bottom of housing 516 than the thinner battery pack containing the smaller battery cell.

The bayonet mount is a fastening mechanism consisting of a cylindrical male side (battery pack 640) with one or more radial spring-loaded pins 632, and a female receptor (watch housing 516) with cavities to receive the spring-loaded pins.

To couple a battery pack to watch housing 516, the spring-loaded pins on the battery pack are aligned with the cavities in the interior wall of watch housing 516. The spring then pushes the male connector into the cavity in watch housing 516 to keep the pin locked into place.

The top surface of battery pack housing 641 includes five concave mating receptacles for mating with corresponding spring-loaded pins 611-615. Concave mating receptacles 622 and 623 for spring-loaded pin connectors 612 and 613 are indicated in FIG. 11. Battery pack housing 641 also features side spring-loaded pins 632, 633 (only spring-loaded pin 632 is shown) that serve the bayonet mount that secures battery pack housing 641 in watch housing 516. The release of spring-loaded pins 632, 633 and 612-615, into their respective concave mating receptacles, or sockets, provides haptic feedback to the user when battery pack housing 641 is secured in watch housing 516.

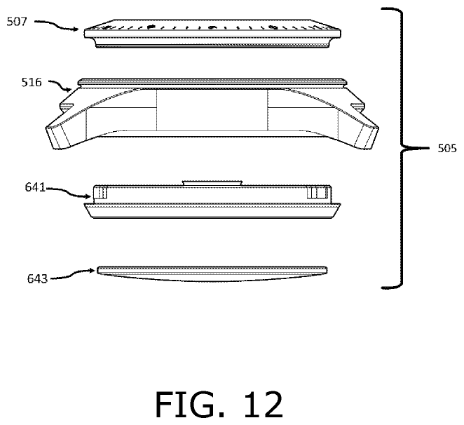

Reference is made to FIG. 12, which is an exploded, side view of stacked components in electronic watch 505: faceplate 507, watch housing 516, battery pack housing 641, and battery pack cover glass 643.

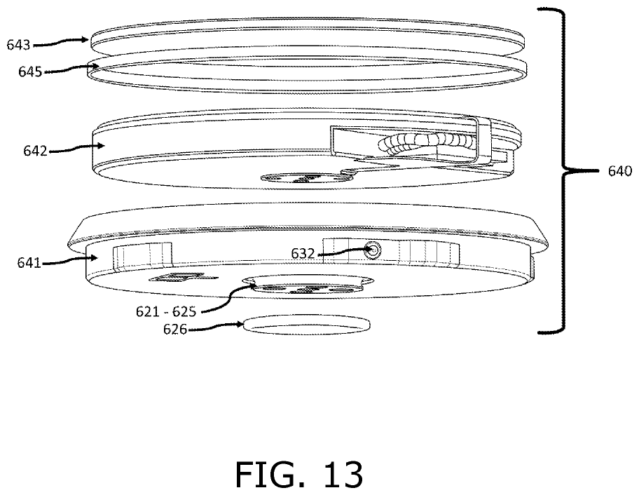

Reference is made to FIG. 13, which is an exploded, perspective view of stacked components in battery pack 640: battery pack cover glass 643, bezel 645, battery cell 642, and battery pack housing 641. Battery pack cover glass 643 is held in place by bezel 645. The bottom of battery pack housing 641 features a raised platform containing concave mating receptacles 621-625 for spring-loaded pin connectors 611-615. The raised platform is surrounded by toric joint 626, forming a seal by being compressed at the interface between the battery pack and the watch housing. When battery pack 640 is disconnected from watch housing 516 by releasing the bayonet mount mechanism, the toric joint 626 compression is released ejecting battery pack 640 from the watch. To release the bayonet mount of battery pack 640 from watch housing 516, battery pack housing 641 is rotated in watch housing 516. The radius of toric joint 626 is significantly smaller than the radius of battery pack 640, to facilitate overcoming friction between toric joint 626 and watch housing 516 when rotating battery pack housing 641, due to torque generated by rotating battery pack housing 641. Toric joints are also referred to as O-ring gaskets.

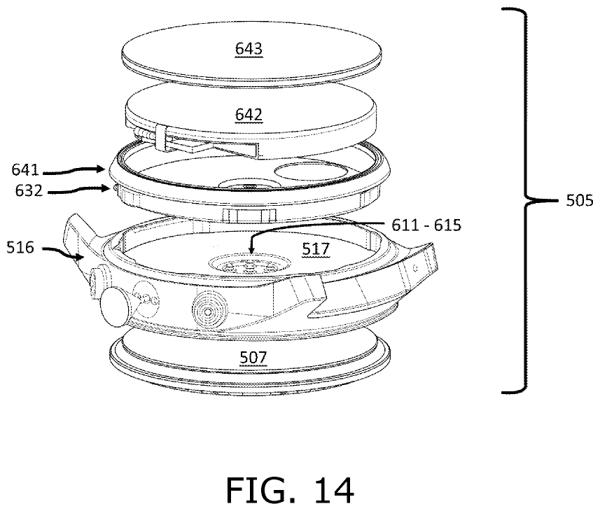

Reference is made to FIG. 14, which is an exploded, perspective view from the bottom of stacked components in electronic watch 505: faceplate 507, watch casing 516, battery pack housing 641, battery cell 642, and battery pack cover glass 643. Watch casing 516 features partition 517 that divides the interior of casing 516 into two, stacked cavities. One cavity serves as a housing for main PCB 600 and display 605, and the second cavity serves as a housing for battery pack 640. Partition 517 is configured with a central transverse hole, through which spring-loaded pin 611 passes, surrounded by a plurality of transverse holes, through which spring-loaded pins 612-615 pass. As discussed hereinabove, spring-loaded pins 611-615 extend from main PCB 600 to connect to battery cell 642.

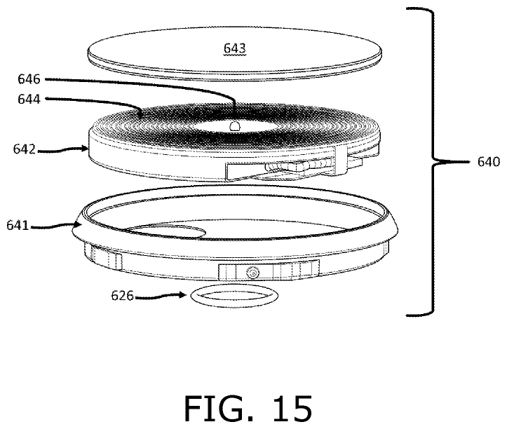

Reference is made to FIG. 15, which is an exploded, perspective view from the bottom of stacked components in battery pack 640: O-ring gasket 626, battery pack housing 641, battery cell 642, and battery pack cover glass 643. FIG. 15 shows wireless charging coil 644 on the upper surface of battery cell 642, for wireless charging of battery cell 642. Wireless charging is done by placing battery pack 640 face-down on a wireless charging mat, i.e., with battery pack cover glass 643 facing the charging mat. Battery cell 642 can thus be charged wirelessly in this manner, both when battery pack 640 is inside watch housing 516, and when battery pack 640 is outside, and separate from, watch housing 516.

At least one LED 646 is mounted between battery cell 642 and cover glass 643, e.g., at the center of wireless charging coil 644. When battery pack 640 is placed on a wireless charging mat, LED 646 is activated to illuminate cover glass 643 whereby a glow is emitted along the edges of cover glass 643 to indicate the charging status. When LED 646 is a multicolor LED, different color illuminations are used. For example, red illumination indicates that the battery is less than 40% charged, yellow illumination indicates that the battery is charged 40-80%, and green illumination indicates that the battery is more than 80% charged. This illumination is visible to the user as a glow along the perimeter of cover glass 643 even when cover glass 643 faces the charging mat.

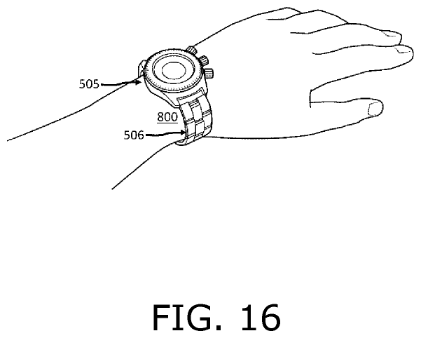

Reference is made to FIG. 16, which is a simplified illustration of electronic watch 505 worn on a user's wrist 800 with watch band 506.

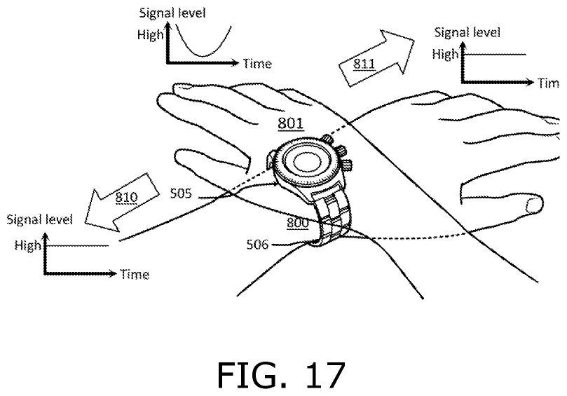

Reference is made to FIG. 17, which is a simplified illustration of user interface hand wave gestures for an electronic watch, in accordance with an embodiment of the present invention. FIG. 17 shows hand 801 waving across and above watch 505 on wrist 800. Two directions for the wave gesture are indicated, 810 and 811. As hand 801 passes across the upper surface of watch 505 the hand's shadow passes across the upper surface of watch 505. This shadow reduces the amount of ambient light that arrives at the PDs through faceplate 507, as discussed hereinabove with reference to FIGS. 5 and 6.

For example, a wave gesture indicated by arrow 811 is performed by the user's right hand 801 over watch 505 worn on the user's left wrist 800. The wave begins above the user's left forearm and moves through the airspace above watch 505 toward the user's left hand, as indicted by arrow 811. This movement is initially detected by the detectors in electronic watch 505 mounted under faceplate 507 at the 9-o'clock position, proceeds to be detected by the detectors under the 6-o'clock and 12-o'clock positions, and is finally detected by the detectors under the 3-o'clock position. At each such detector, the amount of ambient light detected declines as the hand approaches the airspace above the detector, and increases as the hand moves past the detector. The detections are illustrated in three graphs in FIG. 17: the graph on the left shows a steady detection level prior to the hand blocking any of the ambient light from arriving at the detector; the middle graph shows a decline in detected ambient light as the right hand covers the target detector, followed by an increase in detected light as the hand moves beyond the target detector; and the graph on the right shows a subsequent steady detection level after the hand no longer blocks any of the ambient light from arriving at the detector. By comparing the detection levels at each detector over time, the system determines the direction of the wave gesture.

A wave gesture in the opposite direction, beginning above the wearer's left hand and proceeding to the airspace above the wearer's left forearm, is indicated by arrow 810. As discussed hereinabove, in certain embodiments of the invention the PDs are arranged in groups along the perimeter of the display pixels, and outputs front the different groups of PDs are used to detect and identify the different wave gestures. Embodiments wherein outputs from all PDs in a group are connected to a single input pin on the processor are also discussed hereinabove.

Another gesture is an approach gesture, where the user's right hand begins above watch 505 and moves downward toward faceplate 507. This causes a decrease in the amount of ambient light detected at each of the detectors. Conversely, as the user lifts his right hand away and upward from faceplate 507, the amounts of detected ambient light increase. In contrast to the wave gesture, where the changes in detection occur at different ones of the detectors at different times during the wave gesture, in the approach and lift gestures the changes in detection occur at all of the detectors at the same time. This difference enables the system to distinguish between these different gestures.

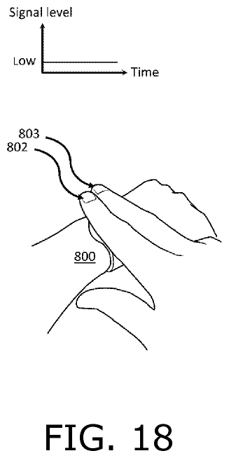

Reference is made to FIGS. 18-20 which are simplified illustrations of a finger-spread gesture, in accordance with an embodiment of the present invention. In this gesture, the user places two fingers 802, 803 above faceplate 507 and spreads the fingers to reveal faceplate 507. At the beginning of the gesture, the two fingers block ambient light from arriving at most, or all, of the detectors. As the fingers are spread, the detectors under the 6-o'clock and 12-o'clock positions detect more ambient light, whereas the detectors under the 9-o'clock and 3-o'clock positions remain blocked from receiving ambient light. If the fingers continue to spread beyond the edges of faceplate 507, all of the detectors will detect ambient light. This unique pattern of ambient light detection over time at the different detectors enables the system to distinguish this gesture from the wave and approach gestures.

FIG. 18 illustrates a first stage in the finger spread gesture, with fingers 802 and 803 covering faceplate 507. A detection graph in this figure, depicting light detection at any one of the detectors, shows reduced ambient light detection.

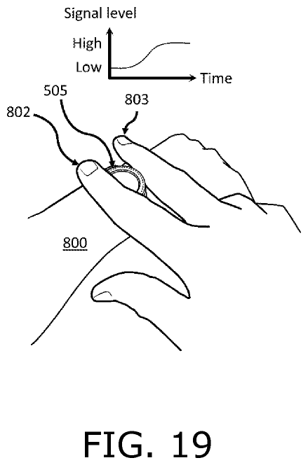

FIG. 19 illustrates a second stage in the finger spread gesture, with fingers 802 and 803 spreading to reveal the middle portion of faceplate 507 between fingers 802 and 803. A detection graph in this figure shows ambient light detection over time at those detectors under the 6-o'clock and 12-o'clock positions: reduced detections at first followed by increased detections. Those detectors under the 9-o'clock and 3-o'clock positions will have increased detections later, so their graph would look similar to the graph in the figure but the increase in detection would be shifted right.

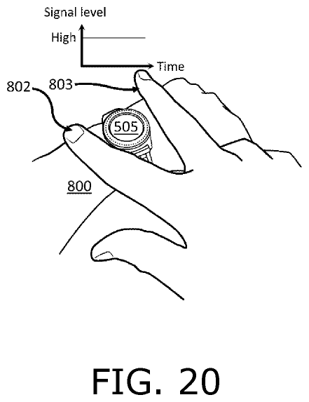

FIG. 20 illustrates a third stage in the finger spread gesture, with fingers 802 and 803 spreading further apart to reveal the entire faceplate 507 between fingers 802 and 803. A detection graph in this figure shows increased ambient light detection the detectors.

In some cases, not all three stages of the finger spread gesture occur, or are necessary in order to detect the gesture. For example, stages 1 and 2 (FIGS. 18 and 19), or stages 2 and 3 (FIGS. 19 and 20), alone are sufficient to indicate the gesture. Similarly, variations of the detection pattern shown in FIG. 19 over time, indicating that fingers 802 and 803 are being spread, is sufficient to indicate the performance of a finger spread gesture. The opposite gesture—a close gesture whereby two spread fingers move towards each other, is detected by the opposite pattern of ambient light detections, namely decreased detections of ambient light at the detectors under the 6-o'clock and 12-o'clock positions over time.

The spread and close gestures according to the present invention are similar to the widely recognized pinch and spread gestures. However, spread and close gestures according to the present invention are performed by the entire finger, whereas conventional pinch and spread gestures are performed with fingertips. The spread and close gestures according to the present invention are designed to be detected by detectors 761-790 arranged above the inactive peripheral area of display 605, as the active area of display 605 lacks a capacitive touch sensor and touch gestures performed on faceplate 507 above the active area of display 605 are not detected.

In certain finger-glide gestures, the user glides his finger along the perimeter of the watch dial. As discussed hereinabove with reference to FIGS. 5 and 6, the light detectors are mounted directly below the perimeter of the watch dial and sufficiently close to the bottom of faceplate 507 so as to limit the optical fibers through which light rays of ambient light can pass to each of the detectors. Thus, an object touching the watch dial blocks ambient light from arriving at the detector mounted directly underneath that location. The system thereby tracks the glide motion of the user's finger along the perimeter of the watch dial over time.

When ambient light levels are low due to the user being in a dark environment, the watch LEDs are activated in order to enable touch detection by the detectors. Thus, when low ambient light is indicated by all of the detectors, processor 617 activates the LEDs mounted on PCB 601. In this case, hand gestures and finger gestures are detected by the inverse of the detections described above, namely, the hand or finger performing the gesture reflects the LED light onto the detectors, thereby increasing the detection level, rather than blocking ambient light from reaching the detectors. Thus, for example the wave gestures illustrated in FIG. 17 performed under low ambient light conditions are detected by increased detections of LED light reflected by hand 801 as it passes across electronic watch 505. Similarly, the finger spread gesture illustrated in FIGS. 18-20 begins with high detections of reflected light while fingers 802 and 803 cover faceplate 507, and thereby reflect a maximum amount of LED light onto their neighboring detectors. These detection levels decline as the fingers spread apart, reaching minimum detection when fingers 802 and 803 don't cover faceplate 507. Likewise, in the case of finger glide gestures along surface 508, the location of the finger is indicated by increased detection levels of reflected light, rather than diminished detection of ambient light. Faceplate 507 ensures that each detector detects light exclusively from its neighboring LEDs.

In embodiments of the invention, the electronic watch includes a gyroscope or accelerometer that is operable to determine whether the electronic watch is stationary. The computer program code running on the processor, causes the processor to reduce an illumination level of the LEDS when the accelerometer or gyroscope indicates that the electronic watch is stationary for an extended period of time, e.g., 30 seconds or a minute or longer, and the detectors detect low levels of ambient light. Under these circumstances it is assumed that the user is resting, based on the lack of movement indicated by the accelerometer or gyroscope, and the dark ambient environment detected by the detectors.

An electronic watch according to the present invention, provides user interfaces for presenting a time of day. The light emitters under dial 515 are activated in a series beginning at that location mapped to the twelve o'clock position and terminating at that location mapped to the position of the current time of day within the 12-hour cycle. The series of emitters can be activated as a serial sequence of activations, in order along dial 515, or by activating all of the emitters in the series simultaneously.

In another user interface, the activation pattern has two steps indicating the hour and minute past the hour, respectively. In this case, a first one or more of the emitters at that location mapped to the position within the 12-hour cycle of the current hour of day is activated, followed by further activating a series of the emitters beginning at that location mapped to the twelve o'clock position and terminating at that location mapped to the position within the 60-minute hour of the number of minutes past the current hour.

Another feature of the time user interface is to activate the emitters to indicate the current time of day when it is determined that the fiber optic faceplate is transitioning from being covered to being exposed, as this indicates that it is likely that the user has turned his wrist and exposed the watch in order to check the time. That the fiber optic faceplate is transitioning from being covered to being exposed is determined based on a series of neighboring ones of the detectors outputting increased values during a time interval. The user interface for indicating time of day by activating LEDs in this situation has a number of advantages. It is easier for a user to see the time by an activated pattern of LEDs along the watch dial than to see the watch hands on display 605. Also, in this case, the display is not woken up each time the user checks the time of day, saving power. Rather, in this scenario the display is reactivated only after the faceplate remains uncovered for an extended period of time.

In the foregoing specification, the invention has been described with reference to specific exemplary embodiments thereof. It will, however, be evident that various modifications and changes may be made to the specific exemplary embodiments without departing from the broader spirit and scope of the invention. Accordingly, the specification and drawings are to be regarded in an illustrative rather than a restrictive sense.

1. An electronic watch, comprising:
a housing;
a display mounted in said housing, the display comprising:
a substrate having an active area and an inactive area; and
a plurality of display pixels in the active area of said substrate;
a printed circuit board (PCB) mounted above the inactive area of said substrate, surrounding the plurality of display pixels;
a first group of light detectors mounted on said PCB, comprising a plurality of light detectors on the right circumference of said display pixels, that, when activated, output values representing amounts of ambient light received by the light detectors in that group;
a second group of light detectors mounted on said PCB, comprising a plurality of light detectors on the left circumference of said display pixels, that, when activated, output values representing amounts of ambient light received by the light detectors in that group;
a fiber optic faceplate above said first and second groups of light detectors, wherein a distance between a bottom surface of the faceplate and each of the light detectors is sufficiently small to limit the optical fibers through which light rays can pass to that detector;
a processor mounted in said housing, connected to said first and second groups of light detectors, that activates each group and stores the group output values; and
a non-transitory computer-readable medium connected to said processor and storing a computer program with computer program code which, when read by said processor, causes said processor to:
identify (i) an in-air wave gesture by a light obstructive object that traverses the airspace above said display, and (ii) a direction of the gesture, wherein the direction is left to right or right to left, based on outputs of said first and second groups of light detectors.

2. The electronic watch of claim 1, wherein, for each said group of light detectors, outputs from all light detectors in the group are connected to a single input pin on said processor.

3. The electronic watch of claim 1, wherein said computer program code, when read by said processor, further causes said processor to identify, for each of said groups of light detectors, whether the light obstructive object is positioned above that group based on outputs from that group.

4. The electronic watch of claim 3, wherein said computer program code, when read by said processor, further causes the processor to:
cease activating said display pixels when said processor identifies that the light obstructive object is positioned above both groups of light detectors.

5. The electronic watch of claim 4, wherein said computer program code, when read by said processor, further causes the processor to:
reactivate said display pixels after said cease activating, in response to said processor identifying that the light obstructive object is no longer positioned above at least one of the groups of light detectors.

6. The electronic watch of claim 1, wherein said computer program code, when read by said processor, further causes the processor to:
identify an in-air approach gesture by a light obstructive object that approaches said display in the airspace above said display based on outputs of said first and second groups of light detectors.

7. The electronic watch of claim 1, wherein said left group comprises an upper left group and a lower left group, and wherein said right group comprises an upper right group and a lower right group, and wherein said computer program code, when read by said processor, further causes the processor to:
identify (i) an in-air wave gesture by a light obstructive object that traverses the airspace above said display in a diagonal direction, and (ii) the diagonal direction, wherein the diagonal directions are between upper left of said display and lower right of said display, and between lower left of said display and upper right of said display, based on outputs of said groups of light detectors.

8. An electronic watch, comprising:
a housing;
a display mounted in said housing, the display comprising:
a substrate having an active area and an inactive area;
a plurality of display pixels in the active area of said substrate; and
peripheral circuitry in the inactive area of said substrate, configured to drive said display pixels;
a PCB mounted above the inactive area of said substrate;
a plurality of light detectors mounted on said PCB, that, when activated, receive ambient light and output values representing the amounts of light received;
a fiber optic faceplate mounted in said housing above said display and said light detectors, acting as a zero-depth window for said display pixels in the active area of said substrate, wherein a distance between a bottom surface of the faceplate and said light detectors is sufficiently small to limit the optical fibers through which light rays can pass to each of said detectors; and
a processor mounted in said housing, connected to said detectors, activating each of said detectors and storing detector output values;
a non-transitory computer-readable medium connected to said processor and storing a computer program with computer program code which, when read by said processor, causes the processor to:
identify, for each of said detectors, whether a light obstructive object is positioned above that detector blocking ambient light from arriving at that detector, based on outputs from that detector.

9. The electronic watch of claim 8, wherein said computer program code, when read by said processor, further causes said processor to calculate a position of a light obstructive object above said fiber optic faceplate by interpolating outputs from a plurality of said detectors.

10. The electronic watch of claim 8, wherein said computer program code, when read by said processor, further causes the processor to:
determine whether said fiber optic faceplate is exposed or covered, based on said identify; and
in response to determining that said fiber optic faceplate is covered, cease activating said display pixels in order to minimize electronic watch power consumption.

11. The electronic watch of claim 10, wherein said computer program code, when read by said processor, further causes the processor to:
determine that said fiber optic faceplate is transitioning from being covered to being exposed, based on increased outputs from a plurality of said detectors, when the number of detectors whose outputs increase, grows over time; and
in response to the determined transitioning, reactivate said display pixels.

12. The electronic watch of claim 8, wherein said computer program code, when read by said processor, further causes the processor to:
recognize in-air wave gestures performed above said fiber optic faceplate, based on ambient light being blocked from different ones of said detectors by an object performing the in-air wave gesture.

13. The electronic watch of claim 8, wherein said computer program code, when read by said processor, further causes the processor to:
recognize in-air approach gestures performed above said fiber optic faceplate, based on reduced detector output values as an object approaches said fiber optic faceplate.

14. The electronic watch of claim 8, wherein said computer program code, when read by said processor, further causes the processor to:
identify finger-glide gestures performed along said fiber optic faceplate above the inactive area of said substrate, based on changes in amounts of ambient light detected by each of said detectors along the path of the gesture.

15. The electronic watch of claim 8, further comprising:
a plurality of light emitters mounted on said PCB and connected to said processor, that, when activated by said processor, emit light through said fiber optic faceplate, whereby said fiber optic faceplate acts as a zero-depth window for said light emitters.

16. The electronic watch of claim 15, wherein said computer program code further causes said processor to activate said emitters in an activation pattern indicating a current time of day.

17. The electronic watch of claim 16, wherein said light emitters surround said active area and are mapped to a clock face dial indicating the hours in a 12-hour cycle,
wherein the activation pattern comprises activating a series of said emitters, the series beginning at that location mapped to the twelve o'clock position and terminating at that location mapped to the position of the current time of day within the 12-hour cycle.

18. The electronic watch of claim 16, wherein said light emitters surround said active area and are mapped to a clock face dial indicating the hours in a 12-hour cycle and the minutes in a 60-minute hour,
wherein the activation pattern comprises initially activating a first one or more of said emitters at that location mapped to the position within the 12-hour cycle of the current hour of day, followed by further activating a series of said emitters beginning at that location mapped to the twelve o'clock position and terminating at that location mapped to the position within the 60-minute hour of the number of minutes past the current hour.

19. The electronic watch of claim 16, wherein said computer program code further causes the processor to:
determine when said fiber optic faceplate is transitioning from being covered to being exposed, based on a series of neighboring ones of said detectors outputting increased values during a time interval; and
in response to the determined transitioning, activate said emitters in the activation pattern indicating the current time of day.

20. The electronic watch of claim 15, wherein, when the outputs of all of said detectors decrease at substantially the same time, indicating that the ambient light has been extinguished, said computer program code, when read by said processor, further causes said processor to illuminate said LEDs, and to determine, for each of said detectors, whether a light obstructive object is positioned above that detector reflecting light from the illuminated LEDs, based on outputs from that detector.

21. The electronic watch of claim 20, further comprising an accelerometer or gyroscope for detecting whether the electronic watch is stationary,
wherein said computer program code, when read by said processor, further causes said processor to reduce an illumination level said LEDs when the outputs of all of said detectors decrease at substantially the same time, indicating that the ambient light has been diminished, and said accelerometer or gyroscope indicates that the electronic watch is stationary.

22-33. (canceled)

34. A method for notifying a user of a time of day, comprising:
provide a display comprising:
a substrate having an active area and an inactive area;
a plurality of display pixels in the active area of said substrate; and
peripheral circuitry in the inactive area of said substrate, configured to drive said display pixels;
arrange a plurality of selectively activatable light emitters above said inactive area surrounding said active area in a manner of a clock face dial indicating the hours in a 12-hour cycle; and
indicate a current time of day by selectively activating a first series of said emitters, the series beginning at that location mapped to the twelve o'clock position and terminating at that location mapped to the position of the current time of day within the 12-hour cycle.

35. The method of claim 34, wherein said selectively activatable light emitters are arranged in a manner of a clock face dial indicating the hours in a 12-hour cycle hours and the minutes in a 60-minute hour, the method further comprising:
indicate a number of minutes past the current hour by activating a second series of said emitters, beginning at that location mapped to the twelve o'clock position and terminating at that location mapped to the position within the 60-minute hour of the number of minutes past the current hour.

36. The method of claim 35, wherein all emitters in said first series are activated concurrently, and all emitters in said second series are activated serially.

37. The method of claim 34, further comprising:
determine when said display transitions from being covered to being exposed; and
in response to said determined transition, indicate the current time of day by selectively activating said emitters.
